(19) United States
(12) Patent Application Publication
(10) Pub. No.: US 2018/0033101 A1
(43) Pub. Date: Feb. 1, 2018

(54) HOME BUYING MOBILE APPLICATION SYSTEM AND METHOD

(71) Applicant: Mike Junior Bennett, Markham (CA)

(72) Inventor: Mike Junior Bennett, Markham (CA)

(21) Appl. No.: 15/221,870

(22) Filed: Jul. 28, 2016

(51) Int. Cl. G06Q 50/16; H04M 1/725; H04L 12/58

(52) U.S. Cl. CPC G06Q 50/16; H04L 51/04; H04M 1/72533

(57) ABSTRACT

A home buying mobile application program and system as used to connect sellers and buyers without the use of a realtor. The home buying mobile application (also known as “HomeSurf”) enables sellers and buyers to communicate with each other via instant messaging (rather than email or exchanging voicemails) to effortlessly conduct real estate transactions, arrange showings, exchange information, and the like.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile applications and more specifically relates to a home buying mobile application that connects sellers and buyers without the use of a realtor.

### 2. Description of Related Art

Buying and selling transactions, particularly those involving substantial assets such as real estate transactions, are typically very complicated and time consuming. There is an entire industry of real estate professionals that derive income from real estate transactions, including agents, attorneys, insurers, and the like. Inclusion of any human resources may add significant expense, delay and complexity to transactions.

Home buying typically involves significant investigative steps on the part of a potential home buyer. The buyer may browse listings on the internet or in printed publications such as newspapers and real estate magazines to find properties the buyer is interested in. The buyer may rely on advertisements to determine which properties are for sale. The buyer may also contact a real estate agent to be shown properties that may be of interest to the buyer.

A realtor is typically used to facilitate selling and buying a home. The REALTOR® will coordinate times for buyers to look at the home and will usually act as an intermediary between the seller and the buyer when bidding on the home. The realtor is typically compensated via a commission when the home is sold. The commission usually amounts to a percentage of the sales price of the home (on average of 3-6%). Depending on the sales price, this can be a lot of money. Several attempts have been made to solve the above-mentioned problems such as those found in U.S. Pub. and Pat. No. 9,106,473 to Altberg; U.S. Pat. No. 7,987,117 to Mozley; 2014/0046792 to Ganesan; 2015/0134484 to Dryden; 2012/0041832 to Sheth; and 2002/0178087 to Henderson. This art is representative of mobile applications. However, none of the above inventions and patents, taken either singly or in combination, is seen to describe the invention as claimed.

### BRIEF SUMMARY OF THE INVENTION

In view of the foregoing disadvantages inherent in the known mobile application art, the present invention provides a novel home buying mobile application system. The general purpose of the present invention, which will be described subsequently in greater detail is to provide a home buying mobile application that connects sellers and buyers without the use of a realtor.

The home buying mobile application system of the present disclosure is designed to make it easier for home buyers and home sellers to sell property without having to spend too much to do so. Specifically, the home buying mobile application serves to eliminate “the middle man” to get a house sold or purchased. Further, the home buying mobile application also reduces time in the process, and having to wait hours and sometimes days before hearing back from a realtor. Also it will not cost the home owner 6% of his/her hard earned equity to sell their house.

A home buying mobile application system for use on an internet-enabled communication device is disclosed herein, in a preferred embodiment, comprising a mobile application software program having a plurality of home-buyer command prompts, a plurality of home-seller command prompts, at least one home-buyer database, at least one home-seller database, a real-time instant messaging platform, and a secure payment processor. The mobile application software program is functionally defined by the plurality of home-buyer command prompts, the plurality of home-seller command prompts, the at least one home-buyer database, the at least one home-seller database, the real-time instant messaging platform, and the secure payment processor bundled in a downloadable package installable on the internet-enabled communication device.

The home buying mobile application may further comprise a variable locking mechanism. The mobile application software program is in wireless communication with the variable locking mechanism via the internet-enabled communication device. The variable locking mechanism is useful for locking at least one door of a real estate property for sale by a seller-user. As may be appreciated, a buyer-user is able to communicate with the seller-user in real time via the real-time instant messaging platform of the mobile application software program for purposes of negotiating a sale of the real estate property without requiring a realtor.

The home buying mobile application system may be sold as a kit. The kit may include the variable locking mechanism in wireless communication with the mobile application software program. The kit may further include installable security and monitoring equipment which may be in wireless communication with the mobile application software program. The kit may further include a set of user installation and use instructions.

According to another embodiment, a method for using the home buying mobile application is also disclosed herein. The method of using the home buying mobile application system may comprise the steps of: downloading a mobile application software program onto an internet-enabled communication device; installing the mobile application software program onto the internet-enabled communication device; opening the mobile application software program via the internet-enabled communication device; creating a seller-user account by a seller-user and alternatively a buyer-user account by a buyer-user; following various command prompts of the mobile application software program; communicating between the seller-user and the buyer-user; and effectuating a real estate purchase without utilizing a realtor. The method ends with tangible results such as a print off of documents and the like related to the transaction.

The present invention holds significant improvements and serves as a home buying mobile application. Preferably, a mobile application should provide a home buying mobile application program that connects sellers and buyers without the use of a realtor, and, yet would operate reliably and be manufactured at a modest expense. Thus, a need exists for a reliable home buying mobile application to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, home buying mobile application system and method, constructed and operative according to the teachings of the present disclosure.

FIG. 1 shows a perspective view illustrating a home buying mobile application system during an ‘in-use’ condition comprising a mobile application software program according to an embodiment of the disclosure.

FIG. 2 is a perspective view illustrating the home buying mobile application system during another ‘in-use’ condition showing a variable locking mechanism according to an embodiment of the present invention of the disclosure.

FIG. 3 is a flow diagram showing a method of using the mobile application program by a seller-user according to an embodiment of the present disclosure.

FIG. 4 is a flow diagram showing a method of using the mobile application program by a buyer-user according to an embodiment of the present disclosure.

FIG. 5 is a flow diagram illustrating a method of use for the home buying mobile application system according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile application and more particularly to a home buying mobile application as used to connect sellers and buyers without the use of a realtor.

Generally speaking, the home buying mobile application of the present invention (also known as “HomeSurf”) enables sellers and buyers to communicate with each other via instant messaging (rather than email or exchanging voicemails). The home buying mobile application also allows buyers who are interested in the same property to see the amount of bids being made in real time, and to place a bid if the buyer is so interested.

The home buying mobile application is designed to make it as simple as possible for home buyers and sellers to get together and buy and sell property without the use of a realtor. The home buying application may provide everything a buyer needs to buy a property and only a finger tap away. The home buying application may make availability calendars from the seller publishable such that buyers can see, provide listings of local stagers that sellers can choose from if they choose to, listings of local home inspectors that buyers can choose from, listings of banks for financing, listings of appraisers, and the like as tangible results.

Sellers can be assured that their homes will be secured via an authentication module programmed into the software coding along with a check-in procedure when interested buyers arrive at a home they wish to visit. As part of the system, interested buyers may request to receive a code useful for accessing a smart lock. By way of example, interested buyers may be given a choice of 30 minutes or 45 minutes to view the house. After viewing, the buyer may then check out and the code may automatically reset. Further, there may be a monitoring device installed in the house configured to interact with the mobile application program. The interested buyer viewing the home may have to sign in and out of that monitoring device. The home owner may be able to monitor when the interested buyer arrives and leaves the house via the mobile application program.

A pledge to users of HomeSurf is to ensure that home sellers keep 98.5% of their hard earned money (or more), and to make the home buying and selling process as simple and easy as possible, and to make it fun and innovative to sell one's home.

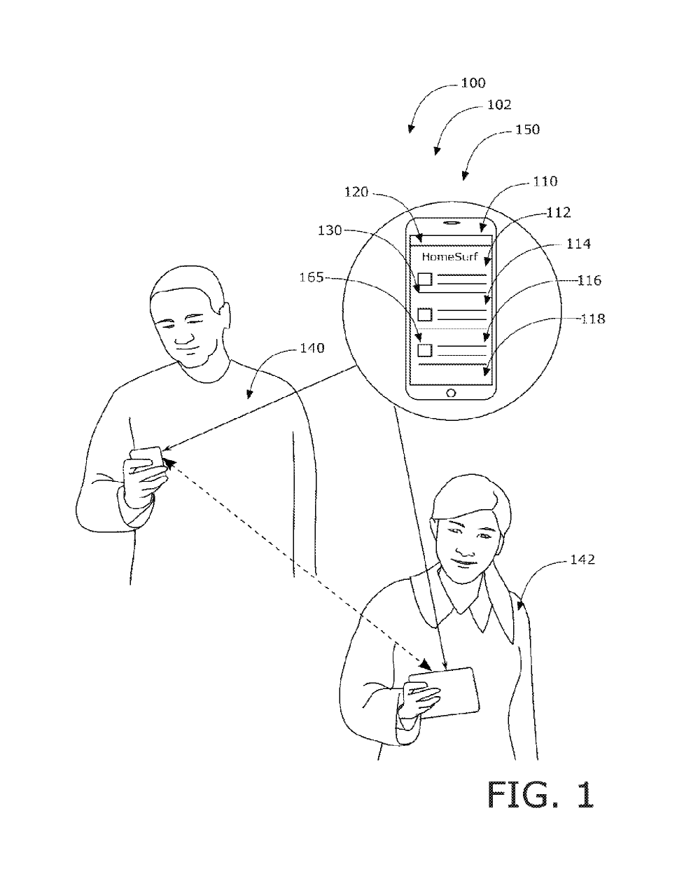

Referring now more specifically to the drawings by numerals of reference there is shown in FIG. 1, home buying mobile application system 100 during ‘in-use’ condition 150 according to one embodiment of the present invention.

Generally speaking, mobile application software program 102 may comprise plurality of home-buyer command prompts 110, plurality of home-seller command prompts 112, at least one home-buyer database 114, at least one home-seller database 116, real-time instant messaging platform 118, and secure payment processor 120. Mobile application software program 102 is functionally defined by plurality of home-buyer command prompts 110, plurality of home-seller command prompts 112, at least one home-buyer database 114, at least one home-seller database 116, real-time instant messaging platform 118, and secure payment processor 120 bundled in a downloadable package installable on internet-enabled communication device 105. As may be appreciated, buyer-user 142 is able to communicate with seller-user 140 in real time via real-time instant messaging platform 118 of mobile application software program 102 for purposes of negotiating a sales price of real estate property for sale 205 without requiring a realtor.

As should be understood by a person having ordinary skill in the art, internet-enabled communication device 105 may comprise a smartphone, a tablet, a laptop computer, a desktop computer, and the like.

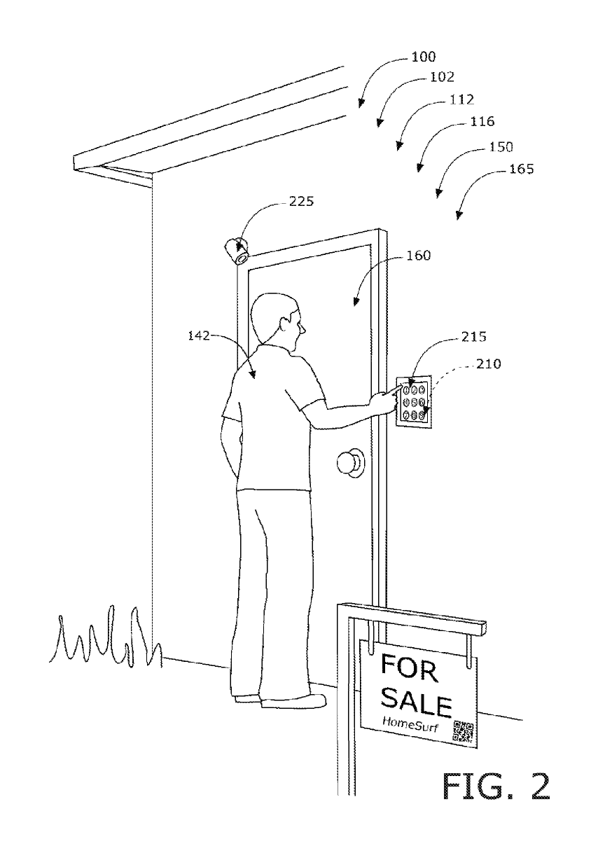

In referring now to FIG. 2 illustrating a perspective view of home buying mobile application system 100 during another ‘in-use’ condition 250 and showing variable locking mechanism 130. As shown, home buying mobile application system 100 may comprise variable locking mechanism 130 useful for locking and remotely unlocking door 220 of real estate property for sale 205. Mobile application software program 102 may be in wireless communication with variable locking mechanism 130 via internet-enabled communication device 105.

In the preferred embodiment of the present invention, variable locking mechanism 130 is useful for locking at least one door 220 of real estate property for sale 205 by seller-user 140. Variable locking mechanism 130 may comprise plurality of random numeric code(s) 210. Each of random numeric code(s) 210 may be configured to unlock door 220 of real estate property for sale 205 when inputted via numeric control panel 215 of variable locking mechanism 130. Variable locking mechanism 130 may be configured to transmit one of random numeric code(s) 210 to buyer-user 142 when requested by buyer-user 142 via home-buyer command prompts 110 of mobile application software program 102. Random numeric code(s) 210 may each comprise a series of random numbers inputtable into numeric control panel 215 of variable locking mechanism 130 by buyer-user 142.

With particular reference to variable locking mechanism 130, it should be noted that random numeric code(s) 210 may be configured to automatically expire upon the occurrence of a pre-programmed event. The pre-programmed event may comprise a time lapse. The time lapse may be 15 minutes, 30 minutes, 45 minutes, 1 hour, or other duration. Further, the pre-programmed event may comprise a cancellation request. The cancellation request may be made by seller-user 140 or by buyer-user 142. The cancellation request may be made via mobile application software program 102.

In continuing to refer to variable locking mechanism 130, it should be noted that mobile application software program 102 may further comprise an authentication module. The authentication module may be configured to authenticate personal information provided by seller-user 140 or by buyer-user 142. The personal information may comprise user identification data. User identification data may be in the form of a drivers license, government issued ID, U.S. passport, or the like. User identification data may be useful for establishing the identity of seller-user 140 or by buyer-user 142. Further, personal information may comprise payment verification data. Payment verification data may comprise credit card information, bank account information, and the like. Further, personal information may comprise real estate ownership verification data. Real estate ownership verification data may be required to be provided by seller-user 140 in order to establish ownership interest in real estate property for sale 205. This may be useful for preventing fraudulent listings.

It should further be noted that pre-programmed event may comprise a decline command. The decline command may be determined by pre-programmed clearance parameters of the authentication module of mobile application software program 102. For example, if buyer-user 142 fails to provide proper authentication of personal data, the authentication module may issue a decline command when buyer-user 142 attempts to request random numeric code 210 via mobile application software program 102.

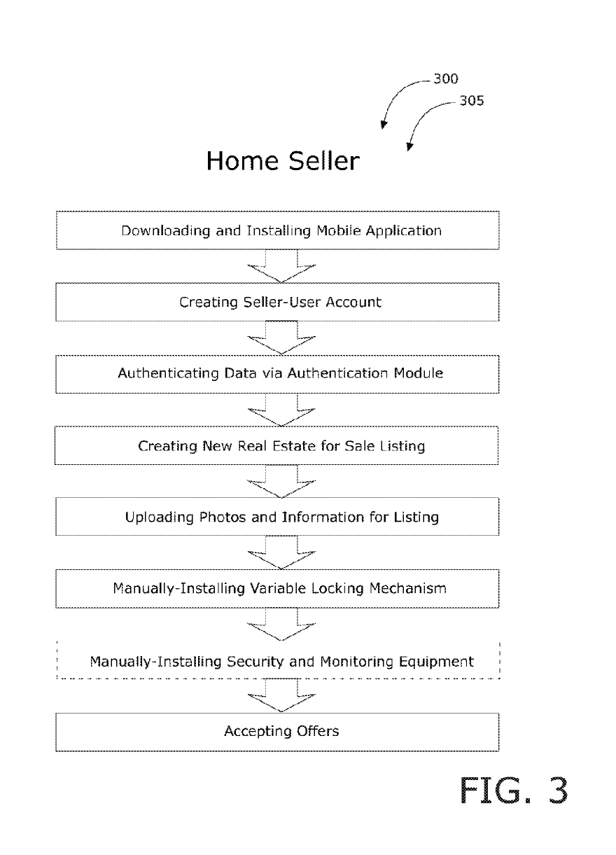

Referring now to FIG. 3 depicting seller-user flow diagram 300 which shows a method of using mobile application program 102 by seller-user 140 according to an embodiment of the present disclosure. As shown, seller-user flow diagram 300 may generally comprise the steps of: downloading and installing mobile application program 102 onto internet-enabled communication device 105 (based on personal preference of seller-user 140); creating a seller-user account which may be retrievably-stored on at least one home-seller database; authenticating data provided by seller-user 140 via the authentication module; creating real estate listing(s) 305 representing real estate property for sale 205; uploading photos and information to real estate listing(s) 305 pertaining to real estate property for sale 205; manually-installing variable locking mechanism 130 to at least one door 220 of real estate property for sale 205; and accepting offers from buyer-user 142 via real-time instant messaging platform 118 of mobile application program 102. It should further be noted that the method of using mobile application program 102 by seller-user according 140 may comprise an optional step of installing security and monitoring equipment 225 around real estate property for sale 205 for security and monitoring purposes.

As should be further noted, seller-user 140 may choose to only post real estate property for sale 205 on mobile application software program 102 (“HomeSurf”) and do all marketing separately, with the exception of variable locking mechanism 130 and security and monitoring equipment 225 as described herein. In such a situation, most of the steps listed above will be available to buyer-user 142 except for generating random numeric code(s) 210.

It should be further noted that a method of business for home buying mobile application system 100 may include offering different packages to seller-user 140. The various package options may each carry a separate price and separate terms and conditions.

As part of one package, the method of business for home buying mobile application system 100 may utilize a professional photographer and a professional installation team. The professional photographer may be trained to take photos of real estate property for sale 205 useful for presenting via real estate listing(s) 305. The professional installation team may be trained to install variable locking mechanism 130 in addition to security and monitoring equipment 225. Once variable locking mechanism 130 is installed, a technician for the professional installation team may explain to seller-user 140 how variable locking mechanism 130 works and if seller-user 140 has any questions would be able to assist at that time. It should be noted that variable locking mechanism 130 will be installed to help secure real estate property for sale 205 and make viewings modern, friendly, and convenient.

Further, the professional installation team may post a “FOR SALE” sign on real estate property for sale 205. The “FOR SALE” sign may comprise a logo or other indicia (for example, “HomeSurf”). Further, the “FOR SALE” sign may comprise a QR code that potential buyers may scan to electronically obtain information about real estate property for sale 205.

In addition, the method of business for home buying mobile application system 100 may utilize a registered appraiser. The registered appraiser may appraise real estate property for sale 205 for user-seller 140 in order to give an estimate of how much real estate property for sale 205 is worth and what user-seller 140 may be able to do to increase its value.

The method of business for home buying mobile application system 100 may further include a professional home stager. Seller-user 140 may be able to choose a home stager provided in a listing via mobile application software program 102. Alternatively, seller-user 140 is free to select a home stager comfortable to seller-user 140 and independent of home buying mobile application system 100.

It should be noted and appreciated that seller-user 140 will be able to monitor all activity relating to real estate listing 305 of real estate property for sale 205 in real time via mobile application software program 102. For example, seller-user 140 may see how many views of real estate listing(s) 305. Seller-user 140 may choose to edit information and add new information at any time. Seller-user 140 may choose to have open houses by posting on real estate listing 305. Of course, seller-user 140 may choose to delete real estate listing 305 at any time.

When buyer-user 142 selects a time and date for viewing real estate property for sale 205 in person, seller-user 140 may receive a notification in real-time via mobile application software program 102. Seller-user 140 may be required to answer enquiries made by buyer-user(s) 142 via real-time instant messaging platform 118 in a timely manner.

When buyer-user 142 arrives to view real estate property for sale 205, seller-user 140 will be notified the moment buyer-user 142 signs in and out in real time. Variable locking mechanism 130 may be configured to create and update a log of who, when and how many times door 220 was opened. Furthermore, random numeric code(s) 210 of variable locking mechanism 130 may be configured to reset each time buyer-user 142 uses it. Seller-user 140 may also monitor who comes in and out via security and monitoring equipment 225 that have installed. As should be understood by those familiar with the art, security and monitoring equipment 225 may comprise video cameras, microphones, and other imaging and sound capturing hardware. As may be appreciated, seller-user 140 may choose to accept offers made by buyer-user 142, or make counter offers, via real-time instant messaging platform 118 mobile application software program 102. Further, seller-user 140 and buyer-user 142 may be able to sign a mutually-agreed-upon offer electronically without requiring a printer. Printers may be used.

The method of business for home buying mobile application system 100 may include a pricing structure based on the appraisal value of real estate property for sale 205. If seller-user 140 sells for more than the appraisal value of real estate property for sale 205, the price will not increase. If seller-user 140 sells for less than the appraisal value of real estate property for sale 205, the price may be lowered accordingly. Once a transaction is complete, home buying mobile application system 100 may transmit all relevant information to a lawyer or representative based on preference of seller-user 140. Further, the seller-user account will be deleted from home-seller database 116 of mobile application software program 102.

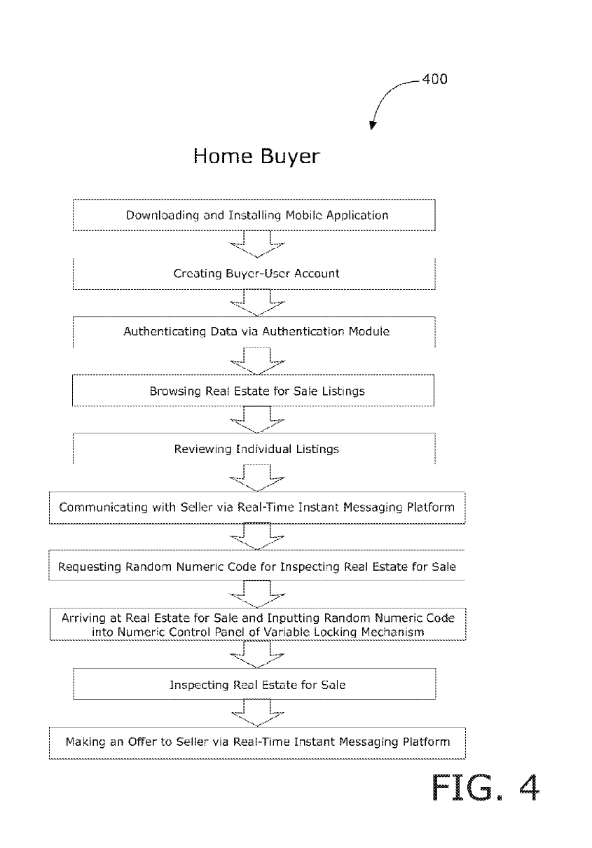

Referring now to FIG. 4 depicting buyer-user flow diagram 400 which shows a method of using mobile application program 102 by buyer-user 142 according to an embodiment of the present disclosure. As shown, buyer-user flow diagram 400 may generally comprise the steps of: downloading and installing mobile application program 102 onto internet-enabled communication device 105 (based on personal preference of buyer-user 142); creating a buyer-user account which may be retrievably-stored on at least one home-buyer database; authenticating data provided by buyer-user 142 via the authentication module; browsing plurality of real estate listing(s) 305; reviewing real estate listing(s) 305; communicating with seller-user 140 via real-time instant messaging platform 118 of mobile application program 102; requesting random numeric code 210 via mobile application program 102 for inspecting real estate property for sale 205; arriving at real estate property for sale 205 and inputting assigned random numeric code 210 into mobile application program 102 when prompted to unlock variable locking mechanism 130; inspecting real estate property for sale 205 and making an offer to seller-user 140 via real-time instant messaging platform 118 of mobile application program 102 (if interested).

As should be further noted, buyer-user 142 may choose to browse through real estate listing(s) 305 if buyer-user 142 isn't serious about purchasing at that very moment without creating the buyer-user account. If buyer-user 142 is ready to buy then buyer-user 142 has to create the buyer-user account. Creating the buyer-user account may require entering driver's license or other State/Federally issued identification of buyer-user 142, credit card information, providing answers to no less than three security questions, and other identification information as may be updated from time to time by the authentication module of mobile application program 102.

After successful registration, buyer-user 142 may then be able to click on real estate listing(s) 305 of interest and may also choose to save real estate listing(s) 305 as “favorites” for easy return access. Each real estate listing(s) 305 may have all relevant information and photos as provided by seller-user 140. On every real estate listing(s) 305 there may be a plurality of home-buyer command prompts 110 (or options available to buyer-user 140). Home-buyer command prompts 110 may comprise options such as: viewing the real estate property for sale 205 in person, making an offer, or interacting with seller-user 140 via real-time instant messaging platform 118 to make further inquiries about real estate property for sale 205. It should be noted that all home-buyer command prompts 110 are made available on each real estate listing 305 upon successful registration of the seller-user account.

Once a home inspector arrives at real estate property for sale 205, the home inspector may be required to “sign in” via mobile application software program 102. After the inspection is complete, the home inspector may be required to file a report via mobile application software program 102 that will be made available to both buyer-user(s) 142 and seller-user(s) 140. Again seller-user 140 may be able to monitor everything.

It should further be noted that buyer-user 142 who happens to be in an area with a HomeSurf sign in front a house, buyer-user 142 may push a button on mobile application software program 102 (geolocation function), scan a QR code on the sign, or take a picture with mobile application software program 102 to get all the info that buyer-user 142 needs about that particular real estate listing 305. If buyer-user 142 wishes to schedule a viewing, mobile application software program 102 may provide a calendar with dates and time that seller-user 140 has inputted for selection. Once buyer-user 142 selects a date and time, that appointment spot will become “filled” and will appear as unavailable instantly to avoid double bookings. A notification will be sent to seller-user 140 as dates and times are filled.

When buyer-user 142 arrives at real estate property for sale 205, buyer-user 142 may be required to check in prior to being given access to an interior of real estate property for sale 205. Checking in may require buyer-user 142 to answer one of the security questions previously entered when buyer-user 142 created buyer-user account, to ensure the identity of buyer-user 142. As buyer-user 142 checks in, random numeric code 210 may be transmitted to buyer-user 142 so buyer-user 142 is able unlock door 220 when prompted via mobile application software program 102.

In one embodiment, numeric control panel 215 may comprise a function of mobile application software program 102. In such a manner, random numeric code 210 may be inputted by buyer-user 142 using internet-enabled communication device 105 to unlock variable locking mechanism 130 via mobile application software program 102. Buyer-user 142 may be given an option of 30 minutes or 45 minutes for viewing real estate property for sale 205. After the selected time period lapses or once buyer-user 142 walks away from real estate property for sale 205, variable locking mechanism 130 will automatically lock door 220 real estate property for sale 205. Further, random numeric code 210 may expire and reset. Advantageously, seller-user 140 may optionally install security and monitoring equipment 225 as a precaution for protection.

Buyer-user 142 may be able to make an offer at any time. If buyer-user 142 wishes to make an offer, buyer-user 142 will simply follow home-buyer command prompts 110. The process is designed to be simple and easy. Buyer-user 142 may further select to add your terms and conditions and give seller-user 140 a time period to respond. Buyer-user 142 may be able to sign an agreement digitally and send to seller-user 140 all via mobile application software program 102.

Buyer-user 142 may further be able to choose a home inspection. The method of business for home buying mobile application system 100 may include a team of qualified local home inspectors available to inspect real estate property for sale 205. When a home inspector is finished, the inspector may file a report via mobile application software program 102 that may be made available to seller-user 140 and buyer-user 142.

If multiple buyer-users 142 are interested in the same real estate property for sale 205, and all buyer-users 142 choose to make an offer then each buyer-user 142 will be able to see that there are buyer-users 142 making offers. The amount offered will not be available to other buyer-users 142 unless there isn't any legal issue with displaying the offer amounts.

Home buying mobile application system 100 may be sold as a kit comprising the following parts: variable locking mechanism 130 in wireless communication with mobile application software program 102; installable security and monitoring equipment 225 in wireless communication with mobile application software program 102; and a set of user use and installation instructions. The kit has instructions such that functional relationships are detailed in relation to the structure of the invention (such that the invention can be used, maintained, or the like in a preferred manner).

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different document delivery combinations, parts may be sold separately, etc., may be sufficient.

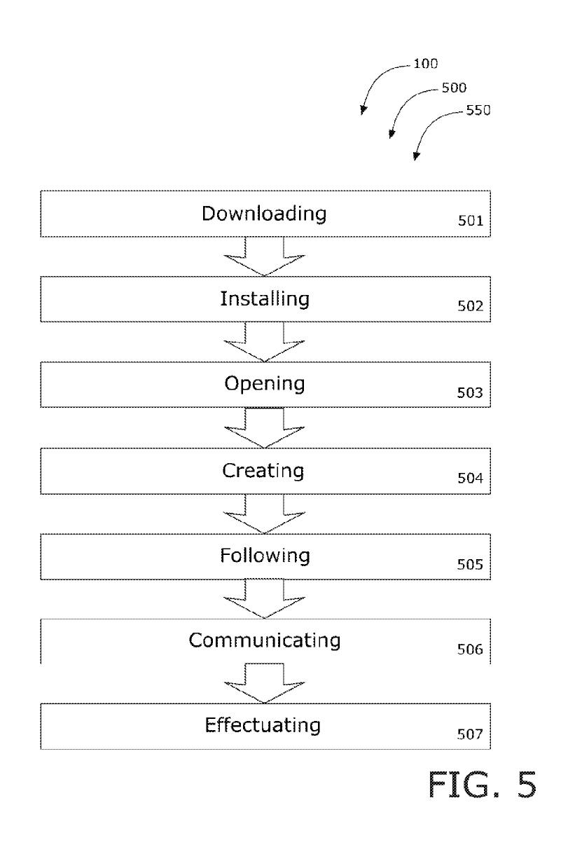

Referring now to FIG. 5 showing flow diagram 550 illustrating method of use 500 for home buying mobile application system 100 according to an embodiment of the present invention of FIGS. 1-4.

As shown, method of use 500 may comprise the steps of: step one 501, installing mobile application software program 102 onto internet-enabled communication device 105; step two 502, opening mobile application software program 102 via internet-enabled communication device 105; creating a seller-user account by seller-user 140 and alternatively a buyer-user account by buyer-user 142; step three 503, following various command prompts of mobile application software program 102; step four 504, communicating between seller-user 140 and buyer-user 142; step five 505, effectuating a real estate purchase of real estate property for sale 205 without utilizing a realtor.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A home buying mobile application system for use on an internet-enabled communication device comprising:
a mobile application software program having;
a plurality of home-buyer command prompts;
a plurality of home-seller command prompts;
at least one home-buyer database;
at least one home-seller database;
a real-time instant messaging platform; and
a secure payment processor; and
a variable locking mechanism;
wherein said mobile application software program is functionally defined by said plurality of home-buyer command prompts, said plurality of home-seller command prompts, said at least one home-buyer database, said at least one home-seller database, said real-time instant messaging platform, and said secure payment processor bundled in a downloadable package installable on said internet-enabled communication device;
wherein said mobile application software program is in wireless communication with said variable locking mechanism via said internet-enabled communication device;
wherein said variable locking mechanism is useful for locking at least one door of a real estate property for sale by a seller-user; and
wherein a buyer-user is able to communicate with said seller-user in real time via said real-time instant messaging platform of said mobile application software program for purposes of negotiating a sale of said real estate property without requiring a realtor.

2. The home buying mobile application system of claim 1 wherein said variable locking mechanism comprises a smart lock useful for remotely unlocking said at least one door of said real estate property for sale by said seller-user.

3. The home buying mobile application system of claim 2 wherein said variable locking mechanism comprises a plurality of random numeric codes, each of said random numeric codes configured to unlock said at least one door of said real estate property when prompted via said mobile application software program.

4. The home buying mobile application system of claim 3 wherein said variable locking mechanism is configured to transmit one of said random numeric codes to said buyer-user when requested by said buyer-user via said plurality of home-buyer command prompts of said mobile application software program.

5. The home buying mobile application system of claim 4 wherein said plurality of random numeric codes automatically expire upon the occurrence of a pre-programmed event.

6. The home buying mobile application system of claim 5 wherein said pre-programmed event comprises a time lapse.

7. The home buying mobile application system of claim 6 wherein said pre-programmed event comprises a cancellation request made by said buyer-user and alternatively said seller-user.

8. The home buying mobile application system of claim 7 wherein said mobile application software program further comprises an authentication module configured to authenticate personal information provided by said buyer-user and alternatively said seller-user.

9. The home buying mobile application system of claim 8 wherein said personal information comprises user identification data.

10. The home buying mobile application system of claim 9 wherein said personal information comprises payment verification data.

11. The home buying mobile application system of claim 10 wherein said personal information comprises real estate ownership verification data.

12. The home buying mobile application system of claim 11 wherein said pre-programmed event comprises a decline command, said decline command determined by pre-programmed clearance parameters of said authentication module of said mobile application software program.

13. The home buying mobile application system of claim 12 wherein said plurality of home buyer command prompts comprises a home browsing option allowing said buyer-user to browse different real estate listing(s).

14. The home buying mobile application system of claim 13 wherein said real estate listing(s) comprise information and photos relevant to said real estate property for sale.

15. The home buying mobile application system of claim 14 wherein said plurality of home-seller command prompts comprises a real estate listing option allowing said seller-user to create a new said real estate listing and provide said information and said photos relevant to said real estate property for sale.

16. The home buying mobile application system of claim 15 wherein said real estate listing(s) comprises an offer option allowing said buyer-user to make a purchase offer to said seller-user via said real-time instant messaging platform.

17. The home buying mobile application system of claim 16 further comprising a plurality of installable security and monitoring equipment enabling said seller-user to monitor activity inside said real estate property for sale via said mobile application software program.

18. A home buying mobile application system for use on an internet-enabled communication device comprising:
a mobile application software program having;
a plurality of home-buyer command prompts;
a plurality of home-seller command prompts;
at least one home-buyer database;
at least one home-seller database;
a real-time instant messaging platform;
an authentication module, said authentication module configured to authenticate personal information provided by a buyer-user and alternatively a seller-user; and
a secure payment processor;
a variable locking mechanism, said variable locking mechanism comprising a numeric control panel, said variable locking mechanism further comprising a plurality of random numeric codes, said variable locking mechanism configured to transmit one of said random numeric codes to said buyer-user when requested by said buyer-user via said plurality of home-buyer command prompts of said mobile application software program; and
a plurality of installable security and monitoring equipment enabling said seller-user to monitor activity inside a real estate property for sale via said mobile application software program;
wherein said mobile application software program is functionally defined by said plurality of home-buyer command prompts, said plurality of home-seller command prompts, said at least one home-buyer database, said at least one home-seller database, said real-time instant messaging platform, said authentication module, and said secure payment processor bundled in a downloadable package installable on said internet-enabled communication device;
wherein said mobile application software program is in wireless communication with said variable locking mechanism via said internet-enabled communication device;
wherein said variable locking mechanism is useful for locking at least one door of a real estate property for sale by said seller-user;
wherein said variable locking mechanism is useful for remotely unlocking said at least one door of said real estate property for sale by said seller-user; and
wherein said buyer-user is able to communicate with said seller-user in real time via said real-time instant messaging platform of said mobile application software program for purposes of negotiating a sale of said real estate property without requiring a realtor.

19. The home buying mobile application system of claim 18 further comprising a kit including:
said variable locking mechanism in wireless communication with said mobile application software program;
said installable security and monitoring equipment in wireless communication with said mobile application software program; and
a set of user installation instructions.

20. A method of using a home buying mobile application system comprising the steps of:
downloading a mobile application software program onto an internet-enabled communication device;
installing said mobile application software program onto said internet-enabled communication device;
opening said mobile application software program via said internet-enabled communication device;
creating a seller-user account by a seller-user and alternatively a buyer-user account by a buyer-user;
following various command prompts of said mobile application software program;
communicating between said seller-user and said buyer-user; and
effectuating a real estate purchase without utilizing a realtor.
